(19) United States
(12) Patent Application Publication
(10) Pub. No.: US 2002/0071283 A1
(43) Pub. Date: Jun. 13, 2002

(54) Collapsible lampshade

(76) Inventor: Alexander Yu, Taipei City (TW)

Correspondence Address: WEBB ZIESENHEIM LOGSDON ORKIN & HANSON, P.C., 700 Koppers Building, 436 Seventh Avenue, Pittsburgh, PA, 15219-1818, US

(21) Appl. No.: 09/734,423

(22) Filed: Dec. 11, 2000

(51) Int. Cl. F21V 1/06

(52) U.S. Cl. 362/352; 362/360

(57) ABSTRACT

A collapsible lampshade includes first and second complementing shell halves each having upper and lower ends, and joining ends which extend from two opposite ends of the upper ends to two opposite ends of the lower ends. Amounting piece, which is disposed within the upper ends of the first and second shell halves and which is connected to the upper end of the second shell half via a second rib, is removably connected to a first rib extending from the upper end of the first shell half. Interconnecting elements are disposed at two opposite ends of the upper and lower ends of first and second shell halves to interlock removably the first and second shell halves. For storage or packaging, the first shell half can be stacked on the second shell half to reduce the volume of the lampshade.

### BACKGROUND OF THE INVENTION

1. Field of the Invention

The invention relates to a lampshade, and more particularly to a collapsible lampshade having two complementing shell halves which can be separated for convenient storage and packaging.

2. Description of the Related Art

Lampshades have existed in various forms in the art. Generally, a lampshade includes a shell to loop around a lamp, which is formed by using a rigid sheeting material, such as a plastic material, or a flexible sheeting material, such as paper or a textile material. In case of the flexible sheeting material, a rigid frame is usually needed to support the flexible sheeting material. A typical frame for a lampshade includes an upper ring, a lower ring, and a plurality of cross ribs interconnecting the upper and lower rings to form a rigid hollow structure. Since the conventional lampshades as such have a unitary structure which is neither collapsible nor separable, they are bulky and require voluminous spaces for storage or packaging. It is desirable that a lampshade be provided with a collapsible structure in order to minimize space for convenient storage or packaging.

### SUMMARY OF THE INVENTION

An object of the present invention is to provide a lampshade of the above-mentioned type including a collapsible shell whose volume can be reduced by separating two complementing shell halves of the collapsible shell.

According to the present invention, a collapsible lampshade comprises: a first shell half including upper and lower ends, and two opposite first joining ends which respectively extend from two opposite ends of the upper end to two opposite ends of the lower end; a second shell half complementing with the first shell half, and including upper and lower ends, and two opposite second joining ends which respectively extend from two opposite ends of the upper end of the second shell half to two opposite ends of the lower end of the second shell half, the second joining ends and said first joining ends being respectively and closely juxtaposed; a mounting piece disposed within and spaced apart from the upper ends of the first and second shell halves, and incorporating at least one first rib interconnecting the mounting piece and the upper end of the first shell half, and at least one second rib interconnecting the mounting piece and the upper end of the second shell half, one of the first and second ribs being removably connected to the mounting piece; and interlocking means disposed on and interconnecting removably the opposite ends of the upper and lower ends of the first shell half and the opposite ends of the upper and lower ends of the second shell half.

### BRIEF DESCRIPTION OF THE DRAWINGS

Other features and advantages of the present invention will become apparent in the following detailed description or the preferred embodiment with reference to the accompanying drawings, of which;

FIG. 1 is a perspective view of a lampshade embodying the present invention;

FIG. 2 is an exploded view of the lampshade of FIG. 1;

FIG. 3 is a fragmentary enlarged elevation view of a portion of the lampshade encircled by a ring A of FIG. 2;

FIG. 4 is the same view as FIG. 3 but with first and second frame halves being interlocked;

FIG. 5 is a fragmentary enlarged sectional view taken along line 5-5 of FIG. 2;

FIG. 6 is a sectional view taken along line 6-6 of FIG. 1; and

FIG. 7 is an exploded view of another embodiment of the lampshade of the present invention.

### DETAILED DESCRIPTION OF THE PREFERRED EMBODIMENT

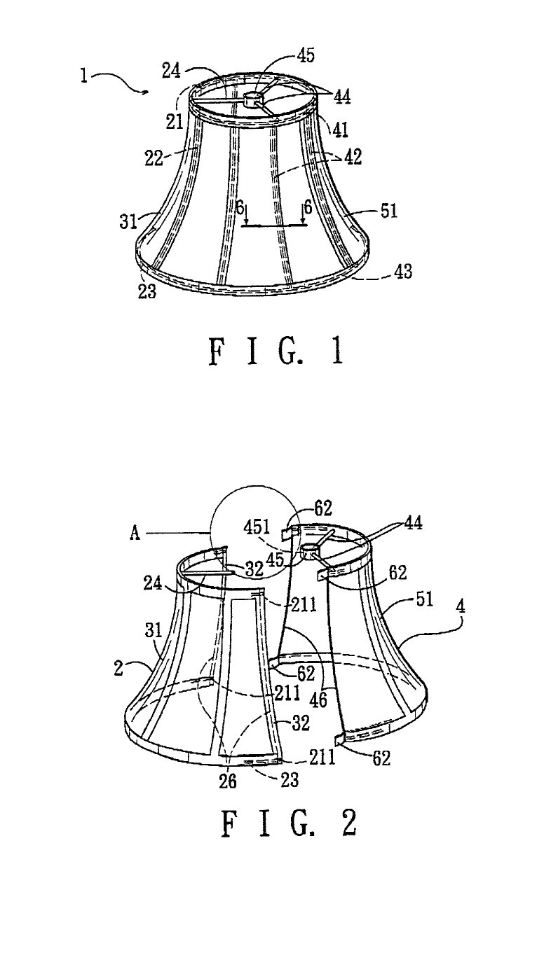

Referring to FIGS. 1 to 6, a lampshade 1 embodying the present invention is shown to include a first shell half 2 constituted by upper and lower ring halves 21, 23, and a plurality of cross rods 22 which extend between the upper and lower ring halves 21, 23 and each of which has opposite ends respectively connected to the upper and lower ring halves 21, 23. A fabric covering 31 is mounted on the upper and lower ring halves 21, 23 and the cross rods 22, and a first rib 24 extends substantially radially inward from the upper ring half 21.

The lampshade 1 further includes a second shell half 4 which is constituted by the upper and lower ring halves 41, 43, and a plurality of cross rods 42 which extend between upper and lower ring halves 41, 43 and each of which has opposite ends respectively connected to upper and lower ring halves 41, 43. A fabric covering 51 is mounted on the upper and lower ring halves 41, 43 and the cross rods 42. The second shell half 4 is capable of complementing with the first shell half 2 to form a substantially truncated cone-shaped shell.

Amounting piece 45, substantially in the form of a ring, is disposed substantially at the center of the upper ring half 41 and is connected to two spaced apart second ribs 44 which in turn extend substantially radially to connect with the upper ring half 41. The first rib 24 is insertable removably into a radial hole 451 of the mounting piece 45.

As best shown in FIGS. 2 & 3, the first and second shell halves 2, 4 respectively have first and second joining ends 26, 46 which are juxtaposed when the first and second shell halves 2, 4 are brought together. The first joining ends 26 extend from two opposite ends of the upper end of the first shell half 2, where the upper ring half 21 is provided, to two opposite ends of the lower end of the first shell half 2, where the lower ring half 23 is provided. The second joining ends 46 extend from two opposite ends of the upper end of the second shell half 4, where the upper ring half 41 is provided, to two opposite ends of the lower end of the second shell half 4, where the lower ring half 43 is provided. Two opposite marginal flanges 32 extend respectively and longitudinally along the first joining ends 26, and project transversely to extend over the second joining ends 46 of the second shell half 4, as best shown in FIG. 6. The marginal flanges 32 are attached to the fabric covering 31 by stitching. Alternatively, adhesive bonding may be used for attachment of the marginal flanges 32. A double-sided adhesive member 63 is provided between each marginal flange 32 and the fabric covering 51 so that each marginal flange 32 is bonded to the fabric covering 51.

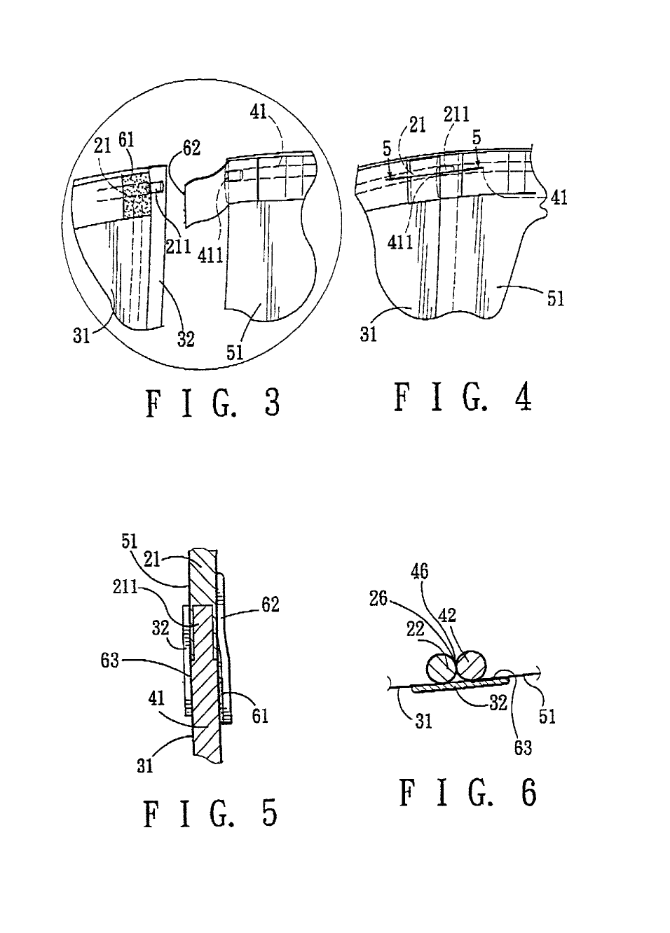

The first and second frame halves 2 and 4 are interlockable by interlocking means provided on the upper and lower ring halves 21, 23, 41, 43. In particular, each of the upper and lower ring halves 21, 23 has two opposite ends which are respectively formed with insert parts 211. Each of the upper and lower ring halves 41, 43 has two opposite ends formed with hollow parts 411 to respectively receive the insert parts 211, as best shown in FIGS. 3 and 4. Hook-and-loop fastener straps 61 and 62 are respectively attached to the inner side of the fabric coverings 31, 51 adjacent to the insert parts 211 and the hollow parts 411 for fastening together the fabric coverings 31, 51.

In assembly, the insert parts 211 of the upper and lower ring halves 21, 23 are inserted into the hollow parts 411, as best shown in FIGS. 4 and 5, and the first rib 24 of the upper ring half 21 is inserted into the radial hole 451 of the mounting piece 45. Then, the hook-and-loop fastener straps 61 and 62 are interlocked, as best shown in FIG. 5, thereby forming a unitary assembly of the lampshade 1. As the marginal flanges 32 of the fabric covering 31 respectively extend over the second joining ends 46 of the second shell half 4, the seams formed at the junctures of the first and second shell halves 2, 4 are hidden behind the marginal flanges 32. Due to the separate first and second shell halves 2 and 4, it is possible to reduce the volume of the lampshade 1 for convenient storage or packaging by stacking the first shell half 2 on the second shell half 4, or vice versa.

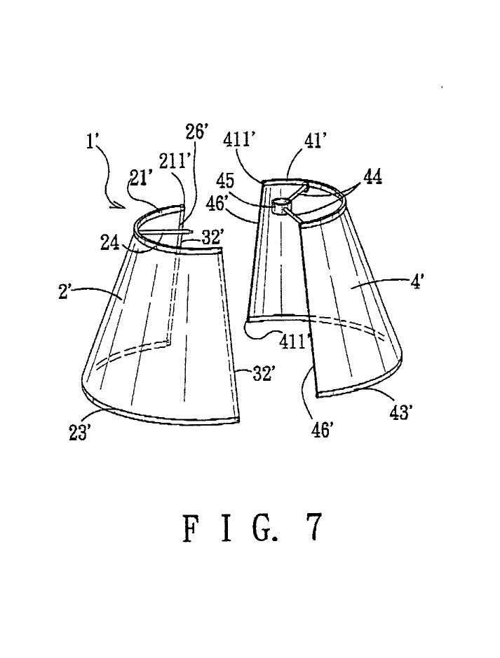

Referring to FIG. 7, another embodiment of the lampshade according to the present invention is shown at 1′ and includes first and second shell halves 2′, 4′ which differ from the first and second shell halves 2, 4 of the previous embodiment in that the coverings thereof are made of a plastic material. The first shell half 2′ includes metallic upper and lower ring halves 21′, 23′ formed with insert parts 211′, whereas the second shell half 4′ includes metallic upper and lower ring halves 41′ 43′ formed with hollow parts 411′. The first shell half 2′ further has integrally formed marginal flanges 32′ along the joining ends 26′. After the first and second shell halves 2′, 4′ are assembled, the marginal flanges 32′ are adhesively bonded to the second shell half 4′ adjacent to the joining ends 46′.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A collapsible lampshade comprising:
a first shell half including upper and lower ends, and two opposite first joining ends which respectively extend from two opposite ends of said upper end to two opposite ends of said lower end;
a second shell half complementing with said first shell half, and including upper and lower ends, and two opposite second joining ends which respectively extend from two opposite ends of said upper end of said second shell half to two opposite ends of said lower end of said second shell half, said second joining ends and said first joining ends being closely juxtaposed;
a mounting piece disposed within and spaced apart from said upper ends of said first and second shell halves, and incorporating at least one first rib interconnecting said mounting piece and said upper end of said first shell half, and at least one second rib interconnecting said mounting piece and said upper end of said second shell half, one of said first and second ribs being removably connected to said mounting piece; and
interlocking means disposed on and interconnecting removably said opposite ends of said upper and lower ends of said first shell half and said opposite ends of said upper and lower ends of said second shell half.

2. The collapsible lampshade as claimed in claim 1, wherein each of said first and second shell halves further includes upper and lower ring halves disposed respectively at said upper and lower ends of the corresponding one of said first and second shell halves, and a covering supported on and extending between said upper and lower ring halves, said interlocking means including interlockable insert parts formed at said opposite ends of said upper and lower ring halves of one of said first and second shell halves, and hollow parts formed at said opposite ends of said upper and lower ring halves of the other one of said first and second shell halves.

3. The collapsible lampshade as claimed in claim 2, wherein said mounting piece is substantially disposed at the center of a space confined by said upper ring halves of said first and second shell halves and is formed as a ring which has a radial hole, said first and second ribs extending radially from said mounting piece, said first rib having one end inserted removably into said radial hole.

4. The collapsible lampshade as claimed in claim 3, further comprising fastening means attached to said first and second shell halves adjacent to said first and second joining ends to fasten together said first and second shell halves.

5. The collapsible lampshade as claimed in claim 4, wherein said fastening means includes hook-and-loop fastener straps.

6. The collapsible lampshade as claimed in claim 4, wherein said first shell half further includes marginal flanges which respectively extend longitudinally along said first joining ends and which projects transversely to extend over said second joining ends.

7. The collapsible lampshade as claimed in claim 6, wherein said marginal flanges are attached adhesively to said second shell half adjacent to said second joining ends.

8. The collapsible lampshade as claimed in claim 5, wherein said covering is made of a fabric material.

9. The collapsible lampshade as claimed in claim 8, wherein each of said first and second shell halves further includes a plurality of cross rods having opposite ends respectively connected to said upper and lower ring halves.

10. The collapsible lampshade as claimed in claim 5, wherein said covering is made of a plastic material.
